(19) United States
(12) Patent Application Publication
(10) Pub. No.: US 2009/0283571 A1
(43) Pub. Date: Nov. 19, 2009

(54) METHOD OF ENHANCING FATIGUE STRENGTH OF FRICTION WELDED JOINT WITH BURRS

(76) Inventors: Masayoshi Hasegawa, Aichi (JP); Hiroaki Suzuki, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/096,274

(22) PCT Filed: Nov. 28, 2006
(86) PCT No.: PCT/JP2006/323705

§ 371 Date: Jun. 5, 2008

(30) Foreign Application Priority Data
Dec. 7, 2005 (JP) 2005-352788

(51) Int. Cl. B23K 20/12

(52) U.S. Cl. 228/112.1

(57) ABSTRACT

The present invention provides a method of enhancing a fatigue strength of a burr toe portion in the vicinity of a friction welded joint with burrs, so that the fatigue strength in the vicinity of the friction welded joint with burrs becomes equivalent to or superior to the strengths of the base bodies of the metallic members, the friction welded joint being obtained by welding two metallic members together by a friction welding technique.

The present invention provides the method of enhancing the fatigue strength of the burr toe portion of the friction welded joint with burrs obtained by welding the two metallic members together by the friction welding technique, wherein the method includes a step of projecting shots to the burr toe portion under a given condition.

### TECHNICAL FIELD

The present invention relates to a method of enhancing a fatigue strength of a friction welded joint with burrs, and more particularly to a method of enhancing a fatigue strength of burr toe portions in the vicinity of a friction welded joint with burrs. The friction welded joint is obtained by welding two metallic members together by a friction welding technique.

### BACKGROUND OF THE INVENTION

In recent years, increases in performance and function of industrial products, and productivity, as well as decreases in energy consumption and resource usage, are strongly requested in industry. One of techniques to weld members that meet such request is a friction welding technique. As shown in FIG. 2, if two members A and B are welded together by the friction welding technique, burrs a and b may be produced at friction welded joint portions obtained by welding the two members A and B together by the friction welding technique.

Conventionally, many of metallic parts manufactured by the friction welding technique are used after the burrs produced by the friction welding technique are removed, in view of the mechanical strength and appearance.

Recently, however, as shown in FIG. 3, the friction welded joint may be used without having the burr removed because it is difficult to remove burr of the structure obtained by joining a plurality of metallic parts and thus having a shape that is difficult to be machined with a lathe, or because it is desired to increase the productivity. Thus, stress concentration occurs at burr toe portions in the vicinity of the friction welded joint with burrs, and as a result, the fatigue strength decreases. Therefore, if the friction welded joint is used without having its burrs removed, it is necessary to increase a diameter of metallic members so that the burr toe portions have a sufficient fatigue strength.

### DISCLOSURE OF INVENTION

The present invention is made in light of the above situations, and the object of the invention is to provide a method of enhancing a fatigue strength of burr toe portions in the vicinity of a friction welded joint with burrs, which friction welded joint is obtained by welding two metallic members together by a friction welding technique, so that the fatigue strength in the vicinity of the friction welded joint with burrs becomes equivalent to or superior to those of the base bodies of the metallic members.

To achieve the above-described object, the present invention provides a method of enhancing a fatigue strength of burr toe portions in the vicinity of a friction welded joint with burrs, which welded joint was obtained by welding two metallic members together by a friction welding technique. The method includes a step of projecting shots to the burr toe portions under a given condition.

Preferably, the metallic members in the present invention may be made of machine structural carbon steel or stainless steel.

Also preferably, in the present invention, the shots may be projected from a tilted direction at an angle in a range of from 45 to 70 degrees to an axial direction of the metallic members.

As is clear from the above, the present invention provides the method of enhancing the fatigue strength of the burr toe portions of the friction welded joint with burrs, which welded joint is obtained by welding the two metallic members together by the friction welding technique. The method includes the step of projecting shots to the burr toe portions under a given condition. Thus, in its practical use the method can produce superior advantages, such as a proper enhancement of the fatigue strength of the burr toe portions of the friction welded joint with burrs, because the fatigue strength at joint portions of the friction welded joint with burrs, which welded joint is obtained by welding the two metallic members together by the friction welding technique, becomes equivalent to or superior to those of the base bodies of the metallic members.

### BEST MODE FOR CARRYING OUT THE INVENTION

An embodiment of a method of enhancing a fatigue strength of burr toe portions of the present invention is described below in detail, based on the drawings. First and second steel round bars to be welded are arranged such that their end surfaces face each other. Then, while the first steel round bar is fixed and the second steel round bar is rotated at a predetermined speed, the end surface of the second steel round bar is pressed to the end surface of the first steel round bar so as to generate frictional heat. Then after the rotation of the second steel round bar is stopped, the second steel round bar is pressed to the first steel round bar with an upsetting pressure that is higher than the friction pressure, so as to weld the first steel round bar with the second steel round bar.

Pressure-welded portions typically become harder and stronger than the base bodies because of a heat effect. However, burrs may be produced at joint portions by pressure welding the two steel round bars together. Thus stress concentration occurs at burr toe portions, and as a result, the joint portion may have a strength lower than the strength of the base bodies. The roundness of a burr toe portion may be varied depending on the level of the upsetting pressure. If the upsetting pressure is decreased, the curvature radius of the roundness of the burr toe portion is increased, and thus the stress concentration factor can be decreased. For steel round bars having a large carbon content, if the upsetting pressure is decreased, a fatigue strength in the vicinity of welded portion of a friction welded joint with burrs becomes equivalent to or superior to strengths of the portions (base body portions) that are located apart from the joint portion of the steel round bars. In contrast, for steel round bars having a small carbon content, even if the upsetting pressure is decreased within a range that allows the steel round bars to be welded, a fatigue strength in the vicinity of a friction welded joint with burrs becomes smaller than the strengths of the base bodies.

Friction welded joints with burrs for standard test pieces were manufactured. In particular, machine structural carbon steels JIS-S25C, S35C, S45C, and S55C with a diameter of 16 mm each were used to manufacture standard test pieces each having a parallel portion with a diameter of 12 mm and a length of 60 mm. Then, each standard test piece was cut into first and second pieces at a center portion thereof with a micro cutter. Then, each first and second standard test pieces were arranged such that their end surfaces face each other. Then, as described above, while the first test piece was fixed and the second test piece was rotated at a speed of 3600 rpm, the first and second standard test pieces were friction welded together at a friction pressure of 51 MPa and an upsetting pressure P2 of 94 MPa. Then the friction welded joint with burrs is manufactured from the test pieces. It is noted that the upsetting pressure P2 of 94 MPa satisfies a condition in which a fatigue strength in the vicinity of a friction welded joint with burrs becomes smaller than the strengths of the base body portions in any steel materials.

Then, shots were projected to the portion within 2 mm of the area extending in an axial direction from a toe in the vicinity of the friction welded joint with burrs of each standard test piece, at a tilt angle (shot angle) of 45 degrees to the axial direction of the standard test piece, in an average particle size of 150 μm and a shot pressure of 0.2 MPa (shooting speed of about 50 m/s) for 12 seconds. Then, a rotating bending fatigue tester with a maximum capacity of 98 MPa was used to perform a fatigue test at room temperature at a speed of about 3500 rpm for each standard test piece after it is subjected to the projection of shots.

In this fatigue test, it was assumed that a fatigue limit be set to a maximum fatigue strength of 2×10⁶ times.

FIG. 1 is a graph showing the results of the fatigue test for the carbon steels S25C and S55C from among the fatigue tests performed.

From FIG. 1, it is found that, in any machine structural carbon steel, the fatigue strength in the vicinity of a friction welded joint with burrs obtained by the friction welding technique was smaller than the strengths of the base body portions, but that, if the shots were projected, the fatigue strength became superior to the strengths of the base body portions.

FIG. 3 shows an example of a structure manufactured by the method of the present invention. There are various other structures that are obtained by joining a plurality of metallic parts and that have shapes that are difficult to be machined with a lathe. For example, such structures include a piping joint shown in FIG. 4, a disc brake plate shown in FIG. 5, a town gas valve shown in FIG. 6, a crank shaft shown in FIG. 7, and a rear axle housing shown in FIG. 8. The present invention can be applied to any of these structures.

The basic Japanese Patent Application No. 2005-352788 filed on Dec. 7, 2005, is hereby incorporated in its entirety by reference into the present application.

The present invention will become more fully understood from the detailed description given herein. However, the detailed description and the specific embodiment are illustrated of desired embodiments of the present invention and are described only for the purpose of explanation. Various changes and modifications will be apparent to those ordinary skilled in the art on the basis of the detailed description.

The applicant has no intention to grant to the public the use of any disclosed embodiments. Among the disclosed changes and modifications, those which may not literally fall within the scope of the present claims constitute, therefore, a part of the present invention in the sense of the doctrine of equivalents.

The use of the terms “a” and “an” and “the” and similar referents in the specification and claims are to be construed to cover both the singular and the plural, unless otherwise indicated herein or clearly contradicted by context. The use of any and all examples, or exemplary language (e.g., “such as”) provided herein, is intended merely to better illuminate the invention and does not pose a limitation on the scope of the invention unless otherwise claimed.

### BRIEF DESCRIPTION OF DRAWINGS

FIG. 1 shows the results of a fatigue test of the present invention when carbon steels S25C and S55C are used.

FIG. 2 is a schematic illustration showing a condition of a friction welded joint with burrs obtained from a test piece manufactured using machine structural carbon steel, which is cut into pieces and then the pieces are welded by a friction welding technique.

FIG. 3 is a front view showing an example of a structure manufactured by a method of the present invention.

FIG. 4 is a perspective view showing a piping joint manufactured by a method of the present invention.

FIG. 5 is a perspective view showing a disc brake plate manufactured by a method of the present invention.

FIG. 6 is a perspective view showing a town gas valve manufactured by a method of the present invention.

FIG. 7 is a perspective view showing a crank shaft manufactured by a method of the present invention.

FIG. 8 is a perspective view showing a rear axle housing manufactured by a method of the present invention.

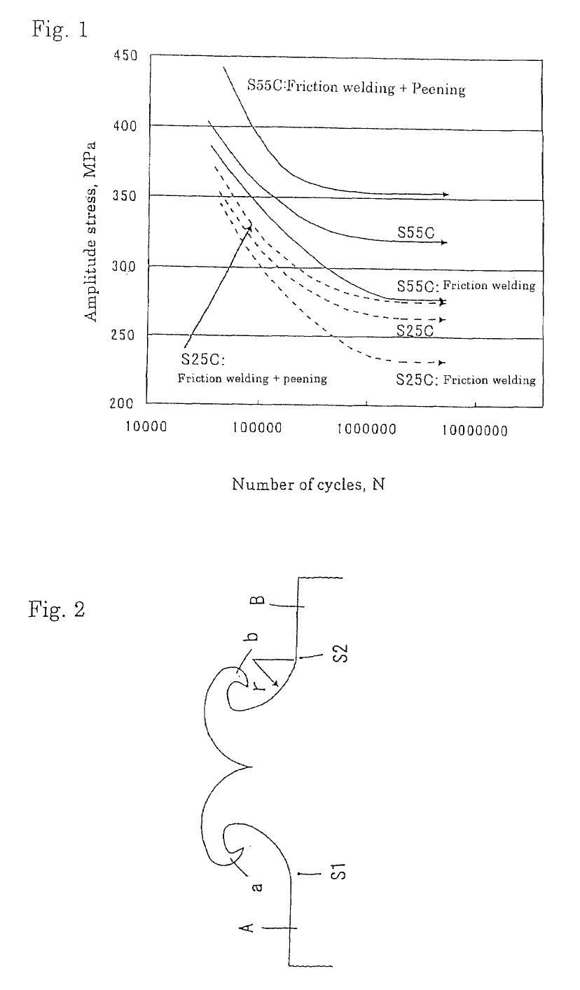

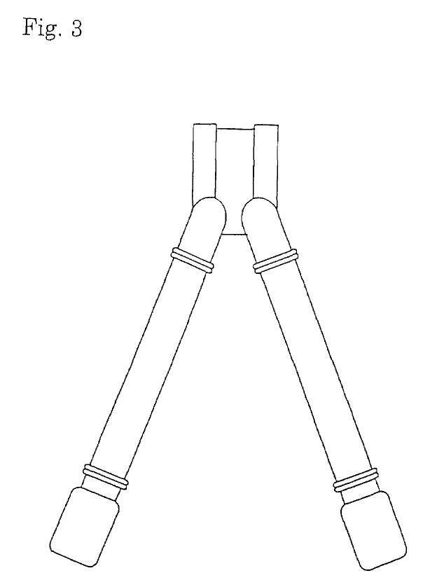

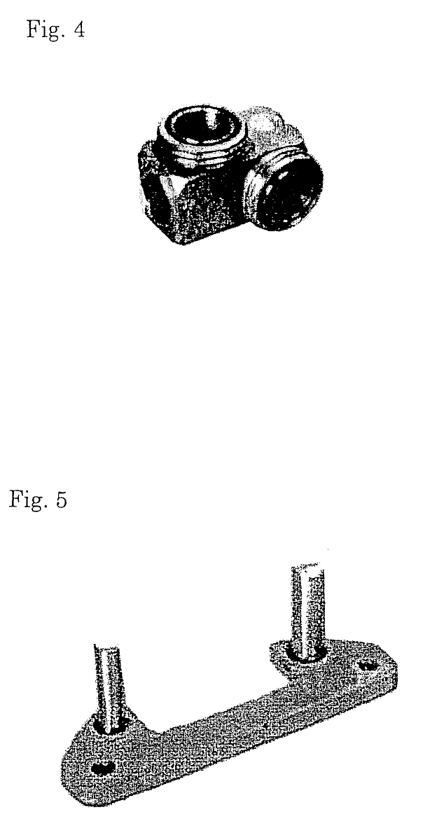

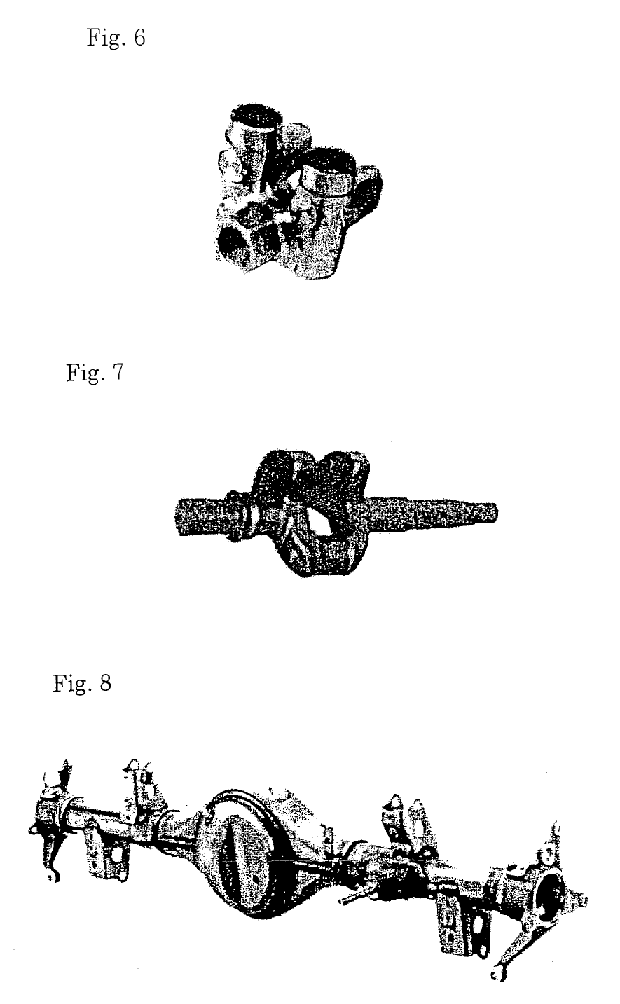

1. A method of enhancing a fatigue strength of burr toe portion of a friction welded joint with burrs obtained by welding two metallic members together by a friction welding technique, the method comprising a step of:
projecting shots to the burr toe portion under a given condition.

2. The method of enhancing the fatigue strength of the friction welded joint with burrs according to claim 1,
wherein the metallic members are machine structural carbon steel or stainless steel with a carbon content in a range of from 0.2% to 1.2%.

3. The method of enhancing the fatigue strength of the friction welded joint with burrs according to claim 1 or 2,
wherein the shots are projected in a tilt direction at an angle in a range of from 45 to 70 degrees to an axial direction of the metallic members.

4. The method of enhancing the fatigue strength of the friction welded joint with burrs according to claim 1 or 2,
wherein the burr toe portion is a portion within 2 mm of an area extending from a toe of the friction welded joint with burrs in the axial direction.

5. The method of enhancing the fatigue strength of the friction welded joint with burrs according to claim 1 or 2,
wherein the two metallic members define a part of a structure that is obtained by joining a plurality of metallic parts and that has a shape that is difficult to be machined with a lathe.

6. The method of enhancing the fatigue strength of the friction welded joint with burrs according to claim 1 or 2,
wherein the two metallic members are made of different materials.
